(19) United States
(12) Patent Application Publication
(10) Pub. No.: US 2007/0134485 A1
(43) Pub. Date: Jun. 14, 2007

(54) Blow molded articles having capped or inserted thermoplastic vulcanizate foam surfaces

(76) Inventor: Daniel J. Collins, Akron, OH (US)

Correspondence Address: William G. Muller, 388 South Main Street, Akron, OH, 44311, US

(21) Appl. No.: 11/297,130

(22) Filed: Dec. 8, 2005

(51) Int. Cl. B29C 44/04; B29C 49/20

(52) U.S. Cl. 428/304.4; 264/45.1; 264/523; 264/45.9

(57) ABSTRACT

Molded article and process for forming a molded article. The process includes integrally bonding foamed thermoplastic sheet or a foamed thermoplastic insert to form a capped or inserted surface onto an expanding parison during a molding process. Air between the expanding parison and the foamed thermoplastic material is evacuated into and at least partially through the foamed cellular structure. Molded articles having soft foam surface characteristics may be formed without additional pre-molding or post-molding operations. The foamed thermoplastic material may include foamed thermoplastic elastomers, foamed thermoplastic vulcanizates, or foamed thermoplastic polyolefins as extruded profiles or sheets. The molding substrate may include HDPE, polypropylene, ABS, polycarbonate or nylon.

### TECHNICAL FIELD

This invention is directed toward molded articles having capped or inserted surfaces comprised of a thermoplastic foamed composition and methods for making the molded articles.

### BACKGROUND ART

It is often desired to incorporate a decorative or functional surface onto a molded article. One technique employed for the application of a cosmetic or functional surface onto a blow molded article employs a secondary operation after molding the primary work piece. The need for a secondary operation increases costs associated with manufacture of such articles.

Another method for providing a desired decorative or functional surface includes preloading an extruded die cut sheet or thin injection molded profile into one half of the cavity of the mold. As part of the blow molding cycle, the inserted surface(s) will bond to the parison substrate during mold closing, parison inflation, and parison cooling.

However, the aforementioned process necessitates limiting the size of the insert. As the surface area of the insert increases, the likelihood of air entrapment also increases. Under normal (non-insert) molding conditions, the air displaced by parison inflation is evacuated from the mold cavity surface by strategically placed air vents in the mold. Placing an insert into the blow mold cavity can block or reduce the effectiveness of these air vents. If the size of a conventional insert is too great, the air cannot be evacuated and air becomes trapped between the insert and the parison, providing unacceptable results.

The problem of air entrapment is addressed in Japanese Patent Document JP2002187198A issued to Dainippon Printing. The disclosed method involves a pre-molding operation whereby holes are bored through the whole surface of the insert sheet to allow the trapped air to escape during the molding process. As with post-molding secondary processes, the pre-molding operation increases manufacturing costs. In addition, the pre-molding operation leaves holes in the decorative surface after molding, which detracts from the visual appearance of the inserted surface. Thus, this disclosed method increases the complexity of providing an insert surface, while providing less than desirable results.

Japanese Patent Document JP2002192604A, also issued to Daimippon Printing, attempts to resolve the air entrapment problem by forming air vent channels or grooves in the internal surface of the insert sheet. The channels or grooves can result in appearance problems in the finished object by way of visible read-through and unevenness of the exposed surface. The effectiveness of the grooves or channels is questionable depending on surface geometry and/or when the surface area becomes extremely large

Thus, the aforementioned methods fail to completely solve the problem of air entrapment encountered in the art while creating other costs and difficulties.

There exists a need in the art for a blow molded article having the desired surface characteristics and processes for imparting such to a blow molded article while avoiding the crucial problem of air entrapment.

### SUMMARY OF INVENTION

In accordance with an exemplary embodiment, a molded article comprises a body comprised of a substrate material and at least one insert region comprised of a foamed thermoplastic composition. In an exemplary embodiment, the article is formed by expanding a parison in a mold. An insert is positioned in the mold prior to introduction of the parison. The insert is formed of a foamed thermoplastic composition having a foamed cell structure. As the parison is expanded in the mold, air between the expanding parison and the insert is evacuated into and partly through the foam cells. During the mold closing, parison expansion, and mold cooling, the insert is integrally bonded to the substrate. Although the term “insert,” is used, the process described herein is also applicable to fully covered or “capped” surfaces for molded articles. Thus the term “insert” should be broadly interpreted to include both conventional inserts and larger, fully capped areas.

In exemplary embodiments, the insert comprises a foamed thermoplastic composition prepared by a process including introducing a foaming agent into a thermoplastic material.

In exemplary embodiments, the parison is comprised of a moldable substrate material. Exemplary substrate material includes high density polyethylene (HDPE), polypropylene, acrylonitrile butadiene styrene (ABS), polycarbonate, and nylon.

Exemplary molded articles include a body comprised of the substrate material and an insert region comprised of the foamed thermoplastic composition. Molded articles formed by the exemplary processes include furniture, vehicle components, playground equipment, medical devices, computer equipment, household utensils, and the like.

### DETAILED DESCRIPTION OF THE INVENTION

Thermoplastic elastomers are a diverse family of rubber-like materials that, unlike conventional vulcanized rubbers, can be processed and recycled like thermoplastic materials. The term “thermoplastic elastomer” (TPE) in general defines thermoplastic materials comprising both “hard” and “soft” regions in its solid state. Such can comprise blends of thermoplastic polymers and/or copolymers, copolymers meaning two or more monomers, and rubbers, or can comprise block copolymers where both hard and soft segments form part of the same copolymer. The term “thermoplastic olefins” (TPO) is used to describe blends which comprise polyolefin thermoplastics and rubber, the rubber phase not being cured. Blends of polyolefins and rubbers in which the rubber phase has been partially or fully cured by a vulcanization process are termed “thermoplastic vulcanizates” (TPV). Other thermoplastic elastomers include the styrenic block copolymers, e.g., unvulcanized styrene/conjugated diene/styrene block-copolymers or blends thereof, both hydrogenated and not hydrogenated.

Thermoplastic vulcanizates (TPVs) are a known class of thermoplastic elastomer and may be characterized by a completely or partially crosslinked rubber phase dispersed within a plastic matrix. The crosslinked rubber phase promotes elasticity but due to the discrete, particulate nature of that crosslinked rubber, does not interfere with plasticity. As such, TPVs exhibit the processing properties of the plastic and the elasticity of the rubber. Further, the TPVs in final form may be removed from other materials to which attached, and then may be melted and molded again without significant loss of mechanical properties making them exceptionally suitable for recycling.

TPVs are conventionally produced by dynamic vulcanization. Dynamic vulcanization is a process whereby a rubber component is crosslinked or vulcanized under intensive shear and mixing conditions within a blend of at least one non-vulcanizing thermoplastic polymer component while at or above the melting point of that thermoplastic. See, for example, U.S. Pat. Nos. 4,594,390 and 6,147,160.

The hardness testing of soft plastics such as rubber, cellular materials, elastomeric materials, thermoplastic elastomers and some hard plastics is most commonly measured by the Shore (Durometer) test. The method measures the resistance of the plastic toward indentation. Shore Hardness, using either the Shore A or Shore D scale, is the preferred method for rubbers/elastomers and is also commonly used for “softer” plastics such as polyolefins, fluoropolymers, and vinyls. The Shore A scale is used for “softer” rubbers while the Shore D scale is used for “harder” ones. The shore A Hardness is the relative hardness of elastic materials such as rubber or soft plastics determined with an instrument called a Shore A durometer. If the indenter completely penetrates the sample, a reading of 0 is obtained, and if no penetration occurs, a reading of 100 results. The reading is dimensionless.

The Shore hardness is measured with an apparatus known as a Durometer and consequently is also known as “Durometer hardness.” The hardness value is determined by the penetration of the Durometer indenter foot into the sample. Because of the resilience of rubbers and plastics, the hardness reading my change over time—so the indentation time is sometimes reported along with the hardness number. The ASTM test number is ASTM D2240 while the analogous ISO test method is ISO 868.

In an exemplary embodiment, a molded article includes a body comprised of a substrate material, and at least one predetermined insert region comprised of a foamed thermoplastic composition. It is desirable in some applications that the foamed thermoplastic composition be a “soft” foam, i.e., having a durometer of less than about 90 Shore A. Exemplary thermoplastic vulcanizates exhibiting the desired softness is available from Advanced Elastomer Systems, LP, Akron, Ohio. One such thermoplastic vulcanizate is SANTOPRENE™ 201-68W228 having typical durometer value of less than 90 Shore A.

The foamed thermoplastic composition useful as the insert material may be formed by foaming suitable thermoplastic. Such exemplary thermoplastic materials include thermoplastic elastomers, thermoplastic vulcanizates, polyolefins, styrenics, styrene-ethylene-butene-styrenes (SEBS), styrene-ethylene/propylene-styrenes (SEPS), styrene-butadiene-styrenes (SBS), polyvinyl chlorides (PVCs), thermoplastic urethanes (TPUs), copolyester thermoplastic copolymers (COPE), copolyamide thermoplastic copolymers (COPA), and fluoroelastomers, and mixtures thereof. In exemplary embodiments, the foamed thermoplastic material may be present as an extruded profile or as a sheet.

In some exemplary embodiments, the insert is prepared by a process including foaming a thermoplastic vulcanizate prepared by adding an elastomer and a crosslinking agent for the elastomer to a thermoplastic material to form a blend, and processing the blend under dynamic vulcanization conditions to at least partially crosslink the elastomer. In subsequent processing, e.g., compounding of thermoplastic vulcanisate pellets by melt processing, a foaming agent may be incorporated into molten or softened thermoplastic vulcanizate to provide the foamed thermoplastic composition after subjection to suitable foaming conditions. In some embodiments, the foaming step occurs as the thermoplastic composition encounters atmospheric temperature and pressure conditions subsequent to mixing or blending under elevated temperature/pressure conditions. Of course, other foaming techniques may be employed by those having skill in the art.

Methods of forming other exemplary foamed thermoplastic compositions are more fully described in Published Patent Application US 2004/0006148 A1, incorporated herein by reference. In the described process a pellet or powdered solid carrier containing a physical foam agent is incorporated into thermoplastic material. The mixture of thermoplastic material and the physical foaming agent is heated and forced through a die before being released to atmospheric pressure, whereupon a foamed article is generated.

In other embodiments, a suitable thermoplastic vulcanizate to be foamed includes a conventional thermoplastic vulcanizate modified by thermoplastic random copolymer of ethylene as more fully described in U.S. Pat. No. 6,399,710, incorporated herein by reference.

In other exemplary embodiments, the insert may be formed of a foamed olefinic thermoplastic elastomer composition which includes an acrylic-modified polytetrafluoroethylene component. Exemplary methods of forming the foam are more fully described in Published Patent Application US 2005/0043488 A1, incorporated herein by reference. For such compositions, the foaming agent may be water, steam, water-generating material, or mixtures thereof.

A foamed extrudate suitable for use as the insert material is disclosed in U.S. Pat. No. 6,329,439, incorporated herein by reference. The disclosed extrudate is formed from a dynamically vulcanizable thermoplastic composition of an elastomer containing no more than 50 parts by weight of polyolefin and at least 50 parts by weight of rubber per 100 parts by weight of polyolefin and rubber.

Other foamed thermoplastic elastomers suitable for use as inserts are disclosed in U.S. Pat. No. 5,070,111, incorporated herein by reference. The disclosed thermoplastic elastomers employ water as the sole foaming agent.

Other foamed thermoplastic compositions and the method of generating them are disclosed in U.S. Pat. No. 6,713,520, incorporated herein by reference. The disclosed foamed compositions employ thermoplastic vulcanizates which include at least one cured rubber, at least one random propylene copolymer, and at least one conventional thermoplastic resin. The thermoplastic vulcanizates are subjected to foaming using conventional foaming procedures.

In any case, the thermoplastic material may be foamed using physical foaming agents, chemical blowing agents, or both. The physical foaming agents may include water, hydrocarbons such as pentane, propane and butane, fluorocarbons, hydrofluorcarbons, chlorofluorocarbons, hydrochlorofluorocarbons, nitrogen and supercritical fluids (i.e., CO₂).

Chemical foaming agents include both exothermic and endothermic foaming agents. Exemplary chemical foaming agents include inorganic foaming agents; nitrous compounds; azo compounds; sulfonylhydrazide compounds; azide compounds, or blends thereof. A more detailed listing of exemplary foaming agents may be found in U.S. Pat. No. 6,713,520, previously incorporated herein.

The exemplary foamed thermoplastic compositions have open/closed or closed cellular structures. The term “open/closed cellular structure” means that some cells in the foamed structure intersect with adjacent cells, while other cells are essentially independent in their structure. The term “closed cellular structure” means that the cells in the foamed structure are predominately independent from intersection with adjacent cells. The open/closed or closed cell structure of exemplary foamed thermoplastic compositions provides unexpected improvements in articles formed by the processes of the present invention. It is believed that the foamed cellular structure diminishes the entrapment of air between the expanding parison and the insert during the molding process. The foamed cellular structure provides an air path whereby air is moved into and partly through the cells. This movement of air in and through the foamed insert during the molding process eliminates the need for pre-molding modifications to the insert material, such as is taught in the prior art.

In an exemplary process, an insert comprised of a foamed thermoplastic composition having a foamed cellular structure is positioned in a mold. The exemplary insert does not require surface modification prior to positioning in the mold. Additionally, the foamed cellular structure allows the insert to have larger dimensions or more complex geometry than unfoamed thermoplastic inserts known in the prior art.

In exemplary embodiments, the insert does not require the addition of an adhesive on the internal surface in order to bond sufficiently with the substrate. Also, in exemplary embodiments, the insert may overlie one or more mold vents without effecting the appearance or performance of the final molded article.

After the insert is positioned in the mold, a parison comprised of a moldable substrate material is introduced into the mold and subjected to an expansion step, using conventional molding techniques suitable for the particular substrate material. The expansion process may occur at an elevated temperature.

During at least a portion of the expansion step, the insert contacts at least a portion of the outer surface of the expanding parison and is integrally bonded thereto. Also, during at least a portion of the expansion step, the air between the expanding parison and the insert is evacuated into and at least partly through one or more cells in the foamed insert.

In exemplary embodiments, the foamed insert is prepared by incorporating a foaming agent into a thermoplastic material. The exemplary thermoplastic material and foaming agents are provided above.

In an exemplary embodiment, the process includes preparing the insert by blending an elastomer and a crosslinking agent for the elastomer with the thermoplastic material and processing the blend under dynamic vulcanization conditions to at least partially crosslink the elastomer.

In an exemplary embodiment, the process includes preparing the insert by extruding a foamed profile of the thermoplastic material/foaming agent mixture.

Other improvements in articles formed by the processes of the present invention include the benefits obtained from melt-back from the foamed thermoplastic material and the substrate material. Because articles are generally molded at elevated temperatures, the thermoplastic nature of the materials may be advantageously employed. In exemplary embodiments, chemical compatibility between the foamed thermoplastic insert composition and the thermoplastic substrate material is believed to enhance the adhesion between the insert and hot parison during the molding process. Tests on various articles formed according to the processes of the invention exhibit true cohesive failure at the interface surface, indicating a strong bond.

In order to demonstrate the practice of the present invention, the following examples have been prepared and tested as described in the General Experimentation Section disclosed hereinbelow. The examples should not, however, be viewed as limiting the scope of the invention. The claims will serve to define the invention.

General Experimentation

A foamable thermoplastic vulcanizate available from Advanced Elastomer Systems, LP, Akron, Ohio, SANTOPRENE™ 201-68W228, was used in the following examples. This thermoplastic vulcanizate is particularly recommended for foaming using water. However, the invention is not limited in this respect and can be applied to other thermoplastic materials. Additionally, the present invention can include other ingredients for adjusting properties of the foamed product, including but not limited to fillers, waxes, colorants, and stabilizers, among others.

The exemplary thermoplastic vulcanizate is particularly formulated for low density foamed profile extrusion applications, exhibiting long term sealability, low temperature flexibility and heat weldability. It is polyolefin based. The density range is 0.95 to 0.15, depending on foaming agent level.

The exemplary thermoplastic vulcanizate exhibits the following properties:

| | Referenced | | |
|---|---|---|---|
| Property | Test Method | Test Unit | Typical Value |
| Hardness | | Shore A | |
| 5 s* | ASTM D 2240 | | 68 |
| 15 s | ISO 868 | | 72 |
| Density | ISO 1183/ASTM D 792 | g/cm³ | 0.97 |
| Tensile strength at break** | ISO 37/ASTM D 412 | MPa (psi) | 6.9 (1000) |
| Elongation at break** | ISO 37/ASTM D 412 | % | 400 |
| Tensile stress at | ISO 37/ASTM D 412 | MPa (psi) | 2.3 (330) |
| 100% elongation** | | | |
| Compression set, | ISO 815, Type A/ | % @23° C. | 23 |
| 168 hrs., 25% deflection | ASTM D 395, | (73° F.) | |
| | Method B, Type 1 | % @100° C. | 36 |
| | | (212° F.) | |
| Tensile set | ISO 2285/ASTM D 412 | % | 10 |
| Tear strength | ISO 34, Method B,b/ | kN/m (lb/in)@ | |
| | ASTM D 624, die C | 23° C. (73° F.) | 25 (143) |
| | | 100° C. (212° F.) | 10 (57) |
| Brittle point | ASTM D 746 | ° C. (° F.) | −60 (−76) |

Values are for injection molded plaques, fan-gated, 102.0 mm × 152.0 mm × 2.0 mm (4.000″ × 6.000″ × 0.080″)
*Value is for injection molded plaques, side-gated, 82.6 mm × 117.5 mm × 3.0 mm (3.250″ × 4.625″ × 0.120″)
**Physical properties are measured across the flow direction-ISO type 1, ASTM die C

In a first example, a sample sheet of SANTOPRENE™ 201-68W228 having a thickness of 0.050″-0.060″ was tested in a blow mold tool with fractional melt HDPE as the molding substrate. The article obtained thereby exhibited excellent adhesion between the substrate and the insert material and indicated an absence of air trap at the interface.

A second example utilized the same foamed thermoplastic composition in a sheet having a thickness of 0.080″-0.090″. Results similar to those obtained with the first sample were obtained.

A third trial was performed using an unfoamed thermoplastic vulcanizate, SANTOPRENE™ 201-73, as the insert material in the blow molding process. The article obtained thereby exhibited air entrapment and poor adhesion. Thus, the improvements due to use of the foamed thermoplastic composition were confirmed.

Blow molded articles incorporating foamed thermoplastic composition inserts can provide improved gripping capabilities, improved decorative appearance, enhanced touch or feel, or any combination of the above.

In an exemplary embodiment, the substrate material comprises high density polyethylene (HDPE). Another exemplary work piece substrate comprises polypropylene. Other exemplary work piece substrates comprise thermoplastic or other polymeric material amenable to blow molding techniques such as are well known in the art.

Some exemplary uses of the disclosed process include foamed material used in furniture padding, ice chest lids, blow molded deck boxes, seat backs/seats, arm rests, outdoor furniture (for example stadium seating), computer keyboard rests, nonslip shelving, automotive running boards, hospital head/foot boards, juvenile furniture, playground equipment, and many others.

While the exemplary embodiments have been described with reference to the examples, it is to be understood that modifications or variations may be easily made by a person of ordinary skill in the art without departing from the scope of this invention which is defined by the appended claims.

1. Process comprising:
(a) positioning at least one insert in a mold, wherein the insert is comprised of a foamed thermoplastic composition having a foamed cellular structure;
(b) subsequent to (a), expanding a parison in the mold, wherein the parison comprises a moldable substrate material; and
(c) during at least a portion of (b), integrally bonding the insert with at least one predetermined region of an outer surface of the expanding parison.

2. The process of according to claim 1 further comprising:
(d) during at least a portion of (b), evacuating air from between the expanding parison and the insert into and at least partly through one or more cells in the foamed cell structure.

3. The process according to claim 2 further comprising, prior to (a):
(e) preparing the insert by a process including:
(i) incorporating a foaming agent into a thermoplastic material.

4. The process according to claim 3 wherein the thermoplastic material is at least one member of the group consisting of thermoplastic elastomers, thermoplastic vulcanizates, polyolefins, styrene-ethylene-butadiene-styrenes (SEBS), styrene-ethylene/propylene-styrenes (SEPS), styrene-butadiene-styrenes (SBS), polyvinyl chlorides (PVCs), thermoplastic urethanes (TPUs), thermoplastic copolymers (COPE), copolyamide thermoplastic elastomers (COPA), and fluoroelastomers, and mixtures thereof.

5. The process according to claim 3 wherein the foaming agent is at least one member of the group consisting of physical foaming agents and chemical foaming agents.

6. The process according to claim 3 wherein the process for preparing the insert further comprises:
ii) extruding a foamed profile.

7. The process according to claim 1 wherein the foamed cellular structure includes closed cells and open/closed cells.

8. The process according to claim 1 wherein in (b), the moldable substrate material is at least one member selected from the group consisting of high density polyethylene (HDPE), polypropylene, acrylonitrile butadiene styrene (ABS), polycarbonate, and nylon.

9. The process according to claim 1 wherein in (c) the insert is integrally bonded to the at least one predetermined region in the absence of any additional adhesive.

10. The process according to claim 1 wherein in (a), the insert comprises a thickness of between 0.05 in. (1.27 mm) and 0.10 in. (2.54 mm).

11. The process according to claim 1 wherein the foamed thermoplastic composition has a durometer of less than about 90 Shore A.

12. The process according to claim 1 wherein in (a) positioning the insert includes overlying at least one mold vent of the mold with the at least one insert without modifying an insert surface.

13. A molded article prepared by the process of claim 1, wherein the article includes a body comprised of the substrate material and an insert region comprised of the foamed thermoplastic composition.

14. The molded article of claim 13 wherein the body is selected from the group consisting of outdoor furniture, furniture, vehicle components, playground equipment, medical devices, computer equipment, toys, and household utensils.

15. A process comprising:
(a) preparing an insert comprised of a foamed thermoplastic composition by a process including:
(i) incorporating a foaming agent into a thermoplastic composition to form a foamable thermoplastic composition, and
(ii) extruding the thermoplastic composition under conditions suitable to form a foamed profile of the foamed thermoplastic composition, wherein the foamed thermoplastic composition comprises a foamed cell structure,
(b) positioning the insert in a mold;
(c) subsequent to (b), expanding a parison in the mold, wherein the parison comprises a moldable substrate material;
(d) during at least a portion of (c), integrally bonding the insert with at least one predetermined region of an outer surface of the expanding parison; and
(e) during at least a portion of (c), evacuating air from between the expanding parison and the insert into and at least partly through one or more cells in a foamed cell structure of the foamed thermoplastic composition.

16. The process according to claim 15 wherein said foamed thermoplastic composition is a foamed thermoplastic elastomer.

17. The process according to claim 16 where said thermoplastic elastomer is a thermoplastic vulcanizate that has a durometer of less than about 90 Shore A.
